(19) United States
(12) Patent Application Publication
(10) Pub. No.: US 2012/0327761 A1
(43) Pub. Date: Dec. 27, 2012

(54) RECEIVING APPARATUS, RECEIVING METHOD, AND WIRELESS COMMUNICATION SYSTEM

(75) Inventors: Kazuhisa OBUCHI, Yokohama (JP); Yoshihiro KAWASAKI, Yokosuka (JP)

(73) Assignee: FUJITSU LIMITED, Kawasaki-shi (JP)

(21) Appl. No.: 13/605,512

(22) Filed: Sep. 6, 2012

Related U.S. Application Data
(63) Continuation of application No. PCT/JP2010/054260, filed on Mar. 12, 2010.

(51) Int. Cl. H04L 29/14; H04L 12/56

(52) U.S. Cl. 370/216

(57) ABSTRACT

A receiving apparatus includes a first detecting unit that performs error detection on a packet received from a transmitter, a second detecting unit that performs error detection on each block, of a predetermined size, into which the packet is divided, and a retransmission requesting unit that controls a retransmission request for the packet with respect to the transmitter on the basis of a detection result from the first detecting unit and a detection result from the second detecting unit.

### CROSS-REFERENCE TO RELATED APPLICATION

This application is a continuation application of International Application PCT/JP2010/054260, filed on Mar. 12, 2010, and designating the U.S., the entire contents of which are incorporated herein by reference.

### FIELD

The embodiments discussed herein are related to a receiving apparatus, a receiving method, and a wireless communication system.

### BACKGROUND

A hybrid automatic repeat request (HARQ) is the known standard of a packet retransmission process performed between base stations and mobile terminals. HARQ is used in, for example, Long Term Evolution (LTE) standard, which is a standard set by the 3rd Generation Partnership Project (3GPP).

In a wireless communication system using HARQ, a transmission end, such as a base station, creates a data packet by, for example, puncturing (thinning out) bits from a bit sequence that has been subjected to error correction coding and transmits the created data packet.

If a receiving end, such as a mobile terminal, receives the data packet, the receiving end performs an error detecting process by using a cyclic redundancy check (CRC) that is attached to the data packet. Then, if an error has not been detected in the error detecting process, the receiving end transmits, to the transmission end, an acknowledgment (ACK) indicating that the data packet has been normally received. In contrast, if an error is detected in the error detecting process, the receiving end stores the received data packet in a buffer and transmits, to the transmission end, a negative acknowledgment (NACK) indicating that the data packet has not been normally received.

If the transmission end receives a NACK transmitted by the receiving end, the transmission end retransmits a data packet from which bits are punctured that are different from the bits punctured from the bit sequence in the previously transmitted data packet. If the receiving end receives the data packet that is retransmitted by the transmission end, the receiving end combines the data packet with the data packet stored in the buffer and performs an error detecting process on the combined data packet. In this way, the transmission end and the receiving end in the wireless communication system that uses an HARQ perform a retransmission process on the data packet.

Non-Patent Document 1: “Evolved Universal Terrestrial Radio Access (E-UTRA); Physical Channels and Modulation (Release 9)”, 3GPP TS 36.211 V9.0.0 (2009-12)

Non-Patent Document 2: “Evolved Universal Terrestrial Radio Access (E-UTRA); Multiplexing and channel coding (Release 9)”, 3GPP TS 36.212 V9.0.0 (2009-12)

Non-Patent Document 3: “Evolved Universal Terrestrial Radio Access (E-UTRA); Physical layer procedures (Release 9)”, 3GPP TS 36.213 V9.0.1 (2009-12)

However, with the conventional technology, it is possible that a normal data packet is not received, which is a problem. Such a problem will be specifically described using the example illustrated in FIG. 14.

FIG. 14 is a schematic diagram illustrating an example of a retransmission process performed by a conventional base station and a conventional mobile terminal. In the example illustrated in FIG. 14, a rectangle having the symbol “C” after the numerals represents a control packet and a rectangle having the symbol “D” after the numerals represents a data packet. The control packet mentioned here is a packet that contains control information, such as information on the format of a data packet, and that corresponds to, for example, a physical downlink control channel (PDCCH) in LTE.

It is assumed that control information on a data packet 11D is set in a control packet 11C, that control information on a data packet 21D is set in a control packet 21C, and that control information on a data packet 22D is set in a control packet 22C. Furthermore, it is assumed that the control packet 11C and the data packet 11D are packets whose destination is not a mobile terminal 92. Furthermore, it is assumed that the control packet 21C, the data packet 21D, the control packet 22C, and the data packet 22D are packets whose destination is the mobile terminal 92.

In the example illustrated in FIG. 14, first, a base station 91 transmits the control packet 11C and the data packet 11D (Step S901). Then, the mobile terminal 92 determines whether the control packet 11C transmitted from the base station 91 is to be transmitted to the mobile terminal 92. In this example, because the control packet 11C is not to be transmitted to the mobile terminal 92, the mobile terminal 92 determines that the control packet 11C is not to be transmitted to the mobile terminal 92. However, the mobile terminal 92 may sometimes erroneously determine that the control packet 11C is to be transmitted to the mobile terminal 92. In the following, the reason for the mobile terminal 92 erroneously making this determination will be described.

For example, it is assumed that the control packet 11C is a PDCCH. A CRC having, for example, a user ID is attached to the PDCCH. Accordingly, if an error is detected in the PDCCH during the CRC checking, the mobile terminal 92 determines that the PDCCH is to be transmitted to a mobile terminal other than the mobile terminal 92 and, on the basis of the PDCCH, does not perform a receiving process on the data packet. However, because a 16-bit CRC is attached to the PDCCH, there may be a case in which the mobile terminal 92 determines, with the probability of about “½¹⁶”, that the PDCCH is to be transmitted to the mobile terminal 92 even though the destination of the PDCCH is not the mobile terminal 92. In such a case, the mobile terminal 92 may possibly perform the receiving process on the data packet on the basis of the PDCCH.

In the example illustrated in FIG. 14, it is assumed that the mobile terminal 92 has erroneously determined that the control packet 11C is to be transmitted to the mobile terminal 92. Accordingly, the mobile terminal 92 performs the receiving process on the data packet 11D on the basis of the control packet 11C. Specifically, the mobile terminal 92 receives the data packet 11D and performs the error detecting process on the data packet 11D. Then, the mobile terminal 92 detects an error in the error detecting process. The reason for this is that the mobile terminal 92 and another mobile terminal to which the data packet 11D is to be transmitted usually have different data size of a data packet or a modulation technique performed on a data packet transmitted to the base station 91. Then, the mobile terminal 92 stores the data packet 11D, in which an error has been detected, in the buffer (Step S902) and transmits a NACK to the base station 91 (Step S903).

Thereafter, the base station 91 transmits the control packet 21C and the data packet 21D (Step S904). The mobile terminal 92 receives the data packet 21D that is to be transmitted to the mobile terminal 92 on the basis of the control packet 21C that is to be transmitted to the mobile terminal 92. At this time, for example, if the data packet 21D and the data packet 11D in the buffer each have the same HARQ process number and the same new data indicator, the mobile terminal 92 combines the data packet 21D with the data packet 11D (Step S905).

In the example illustrated in FIG. 14, the mobile terminal 92 creates a data packet 31D by combining the data packet 21D with the data packet 11D. Then, the mobile terminal 92 performs the error detecting process on the combined data packet 31D. As described above, because the data packet 11D is not the data packet to be transmitted to the mobile terminal 92, the data packet 31D created by combining the data packet 11D with the data packet 21D contains an error. Accordingly, the mobile terminal 92 detects an error in the error detecting process performed on the data packet 31D. Then, the mobile terminal 92 stores the data packet 31D in the buffer (Step S906) and transmits a NACK to the base station 91 (Step S907).

If the base station 91 receives the NACK from the mobile terminal 92, the base station 91 retransmits, to the mobile terminal 92, both the control packet 22C and the data packet 22D from which bits are punctured that are different from the bits punctured in the data packet 21D (Step S908). If the mobile terminal 92 receives the data packet 22D, the mobile terminal 92 creates a data packet 32D by combining the data packet 31D with the data packet 22D (Step S909). As described above, because many errors are contained in the data packet 31D, the mobile terminal 92 also detects errors in the error detecting process performed on the data packet 32D. Accordingly, the mobile terminal 92 stores the data packet 32D in the buffer (Step S910) and transmits a NACK to the base station 91 (Step S911).

As described above, in the wireless communication system that uses HARQ, if the mobile terminal erroneously detects a control packet and receives a data packet that is not to be transmitted to the mobile terminal, the mobile terminal stores, in the buffer, the data packet that is not to be transmitted to the mobile terminal. Accordingly, even if the mobile terminal receives a data packet that is to be transmitted to the mobile terminal from the base station after the mobile terminal erroneously has received the data packet that is not to be transmitted to the mobile terminal, there may be a case in which the mobile terminal combines the received data packet that is to be transmitted to the mobile terminal with the data packet that is not to be transmitted to the mobile terminal. Consequently, there is a possibility that a normal data packet that is to be transmitted to the mobile terminal is not received.

### SUMMARY

According to an aspect of the embodiments, a receiving apparatus includes a first detecting unit that performs error detection on a packet received from a transmitter; a second detecting unit that performs error detection on each block, of a predetermined size, into which the packet is divided; and a retransmission requesting unit that controls a retransmission request for the packet with respect to the transmitter on the basis of a detection result from the first detecting unit and a detection result from the second detecting unit.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an example configuration of a receiving apparatus according to a first embodiment;

FIG. 2 is a schematic diagram illustrates an example of a retransmission process performed by a mobile terminal according to a second embodiment;

FIG. 3 is a block diagram illustrating an example configuration of a base station according to the second embodiment;

FIG. 4 is a schematic diagram illustrating a data packet creating process performed by a data packet creating unit;

FIG. 5 is a block diagram illustrating an example configuration of a mobile terminal according to the second embodiment;

FIG. 6 is a schematic diagram illustrating an example of a response information creating process performed by the mobile terminal according to the second embodiment;

FIG. 7 is a flowchart illustrating a process performed by the mobile terminal according to the second embodiment;

FIG. 8 is a schematic diagram illustrating an example of the frame configuration in a downlink of LTE;

FIG. 9 is a schematic diagram illustrating an example of the frame configuration in a downlink of LTE-A;

FIG. 10 is a block diagram illustrating an example configuration of a base station according to a third embodiment;

FIG. 11 is a block diagram illustrating an example configuration of a mobile terminal according to the third embodiment;

FIG. 12 is a schematic diagram illustrating an example of the error rate of code blocks;

FIG. 13 is a block diagram illustrating a computer that executes a reception control program; and

FIG. 14 is a schematic diagram illustrating an example of a retransmission process performed by a conventional base station and a conventional mobile terminal.

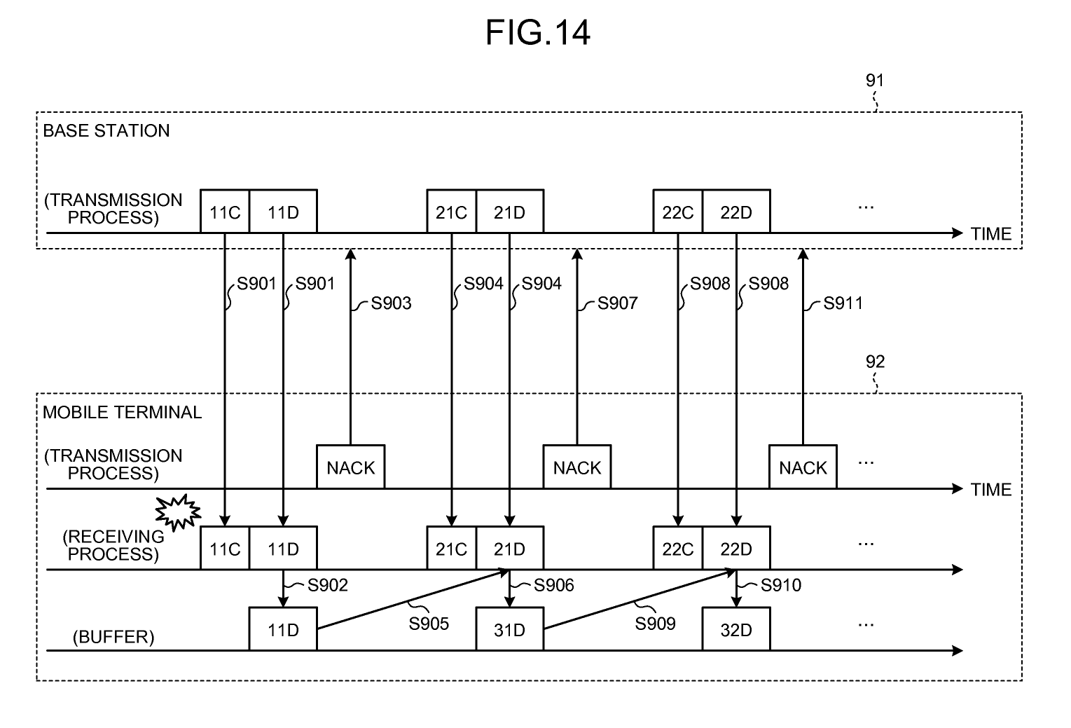

### DESCRIPTION OF EMBODIMENTS

Preferred embodiments of the present application will be explained with reference to accompanying drawings.

The receiving apparatus, the receiving method, and the wireless communication system disclosed in the present application are not limited to the embodiments.

### [a] First Embodiment

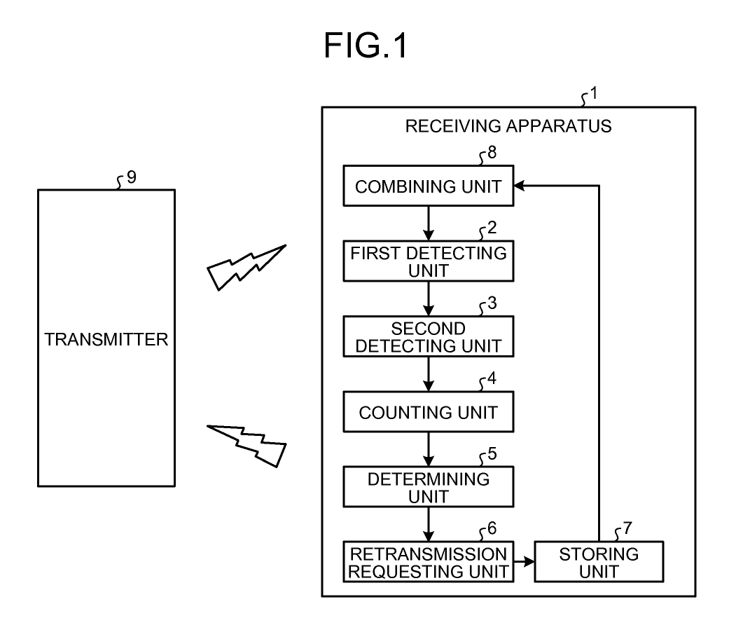

First, a receiving apparatus according to a first embodiment will be described with reference to FIG. 1. FIG. 1 is a block diagram illustrating an example configuration of a receiving apparatus according to a first embodiment. As illustrated in FIG. 1, a receiving apparatus 1 according to the first embodiment performs wireless communication with a transmitter 9. The transmitter 9 is, for example, a base station. The receiving apparatus 1 is, for example, a mobile terminal and includes a first detecting unit 2, a second detecting unit 3, a counting unit 4, a determining unit 5, a retransmission requesting unit 6, a storing unit 7, and a combining unit 8.

The first detecting unit 2 performs error detection on a packet received from the transmitter 9. The second detecting unit 3 performs error detection on each block, of a predetermined size, into which the packet is divided. The counting unit 4 counts the number of blocks in which an error has been detected by the second detecting unit 3. If an error is detected by the first detecting unit 2, the determining unit 5 determines whether the number of blocks counted by the counting unit 4 is equal to or greater than a predetermined threshold.

If the determination result obtained by the determining unit 5 indicates that the number of blocks in which an error has been detected is equal to or greater than a predetermined threshold, the retransmission requesting unit 6 does not store the packet in the storing unit 7 and does not request the transmitter 9 to retransmit the packet. In contrast, if the determination result obtained by the determining unit 5 indicates that the number of blocks in which an error has been detected is equal to or less than a predetermined threshold, the retransmission requesting unit 6 stores the packet received from the transmitter 9 in the storing unit 7 and requests the transmitter 9 to retransmit the packet.

As described above, a packet in which an error has been detected is stored in the storing unit 7 by the retransmission requesting unit 6. If the combining unit 8 receives a packet that is retransmitted from the transmitter 9 in response to a retransmission request from the retransmission requesting unit 6, the combining unit 8 combines the received retransmission packet with the packet stored in the storing unit 7.

As described above, if the receiving apparatus 1 according to the first embodiment detects an error in a received packet, the receiving apparatus 1 performs the error detecting process on each block, of a predetermined size, into which the packet is divided. Then, if the number of blocks in which an error has been detected is equal to or greater than a predetermined threshold, the receiving apparatus 1 determines that the packet received from the transmitter 9 is not to be transmitted to the receiving apparatus 1. If the received packet is not to be transmitted to the receiving apparatus 1, the receiving apparatus 1 does not store the packet received from the transmitter 9 in the storing unit 7 that stores therein packets used for the combining process and furthermore the receiving apparatus 1 does not send a retransmission request to the transmitter 9.

Accordingly, even when the receiving apparatus 1 erroneously performs the receiving process on a packet that is not to be transmitted to the receiving apparatus 1, the receiving apparatus 1 does not store the packet that is not to be transmitted to the receiving apparatus 1 in the storing unit 7; therefore, it is possible to prevent the situation in which a normal data packet is not received. For example, even when the receiving apparatus 1 performs the receiving process on a data packet that is not to be transmitted to the receiving apparatus 1 on the basis of the control packet that is not to be transmitted to the receiving apparatus 1, it is possible to prevent the situation in which a normal data packet is not received.

### [b] Second Embodiment

In the following, in a second embodiment, a description will be given of a case in which the receiving apparatus 1 described in the first embodiment is used for a mobile terminal. Furthermore, in the second embodiment, a description will be given of a case in which the transmitter 9 in the first embodiment is a base station.

Retransmission Process Performed by a Mobile Terminal According to the Second Embodiment

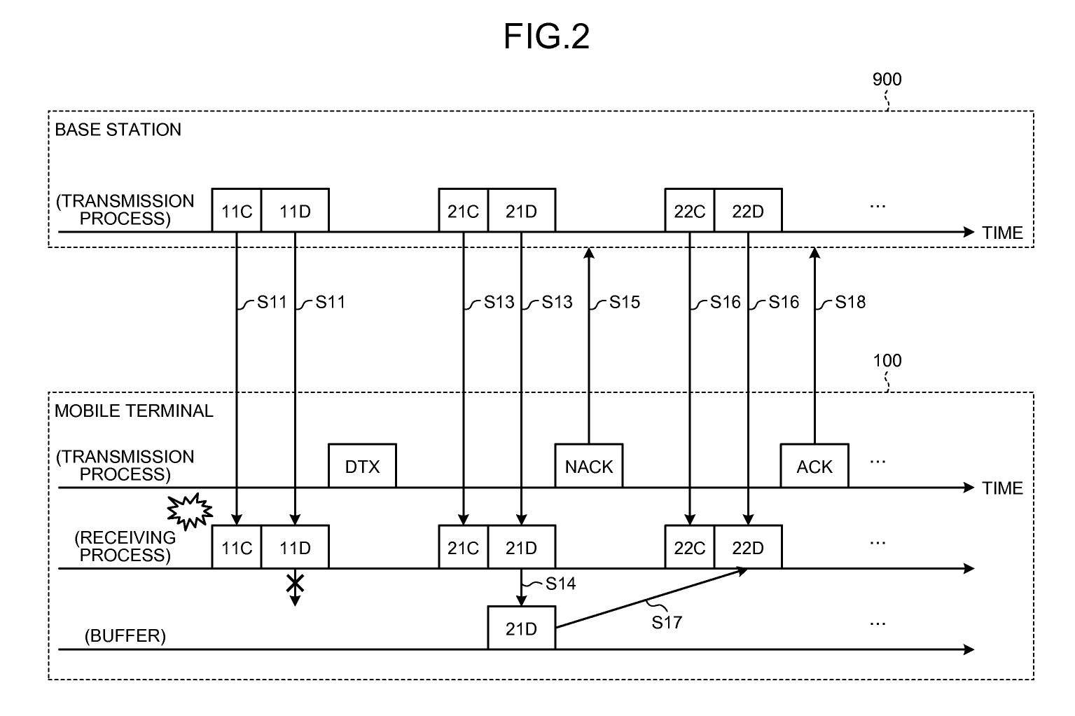

First, a retransmission process performed by a mobile terminal according to the second embodiment will be described with reference to FIG. 2. FIG. 2 is a schematic diagram illustrates an example of a retransmission process performed by a mobile terminal according to a second embodiment. In the example illustrated in FIG. 2, a mobile terminal 100 according to the second embodiment is, for example, a receiving apparatus and performs wireless communication with a base station 900.

In the example illustrated in FIG. 2, it is assumed that the control packet 11C and the data packet 11D are packets that are not to be transmitted to the mobile terminal 100. Furthermore, it is assumed that the control packet 21C, the data packet 21D, the control packet 22C, and the data packet 22D are packets that are to be transmitted to the mobile terminal 100. Furthermore, a CRC used for detecting an error of a data packet is attached to each of the data packets 11D, 21D, and 22D. Furthermore, the CRC is attached to each piece of data that has a predetermined size and is referred to as a “code block (CB)”. The CRC that is attached to a data packet will be described later.

As illustrated in FIG. 2, first, the base station 900 transmits the control packet 11C and the data packet 11D (Step S11). When the mobile terminal 100 receives the control packet 11C, the mobile terminal 100 determines whether the control packet 11C is to be transmitted to the mobile terminal 100. In this case, it is assumed that, although the control packet 11C is not to be transmitted to the mobile terminal 100, the mobile terminal 100 erroneously determines that the control packet 11C is to be transmitted to the mobile terminal 100. Specifically, on the basis of the control packet 11C that is not to be transmitted to the mobile terminal 100, the mobile terminal 100 performs the receiving process on the data packet 11D that is not to be transmitted to the mobile terminal 100.

More specifically, the mobile terminal 100 performs error detection on the data packet 11D. In this case, because the data packet 11D is not to be transmitted to the mobile terminal 100, the mobile terminal 100 detects an error in the data packet 11D. Then, if the mobile terminal 100 according to the first embodiment detects an error in the data packet 11D, the mobile terminal 100 performs error detection for each code block contained in the data packet 11D.

If the number of code blocks in which an error has been detected is equal to or greater than a predetermined threshold, the mobile terminal 100 determines that the data packet 11D is not to be transmitted to the mobile terminal 100. The reason the mobile terminal 100 makes a determination in this way will be described here. For example, if it is assumed that eight code blocks are contained in the data packet 11D, then in such a case, the possibility is low that errors are detected in all of the code blocks contained in the data packet 11D. In other words, the probability that the control packet 11C is erroneously detected is higher than the probability that errors are detected in the eight code blocks. Accordingly, if the number of the code blocks in which an error has been detected is equal to or greater than a predetermined threshold, the mobile terminal 100 determines that the data packet that contains such code blocks is not to be transmitted to the mobile terminal 100.

If the mobile terminal 100 determines that the data packet 11D is not to be transmitted to the mobile terminal 100, the mobile terminal 100 discards the data packet 11D without storing it in the buffer. Then, the mobile terminal 100 enters a discontinuous transmission (DTX) state in which neither an ACK nor a NACK is transmitted to the base station 900 (Step S12).

Thereafter, the base station 900 transmits the control packet 21C and the data packet 21D (Step S13). It is assumed that the data packet 21D is not a retransmitted packet but is a new packet that is transmitted to the mobile terminal 100 for the first time. The mobile terminal 100 receives, on the basis of the control packet 21C that is to be transmitted to the mobile terminal 100, the data packet 21D that is to be transmitted to the mobile terminal 100. At this time, because the data packet is not in the buffer, the mobile terminal 100 does not combine the data packet 21D with the data packet in the buffer. Then, the mobile terminal 100 performs error detection on the data packet 21D. In this example, it is assumed that the mobile terminal 100 detects an error in the data packet 21D.

Then, the mobile terminal 100 performs the error detection on each of the code blocks contained in the data packet 21D. In this example, it is assumed that the number of code blocks detected by the mobile terminal 100 is less than a predetermined threshold. Specifically, the mobile terminal 100 determines that the data packet 21D is to be transmitted to the mobile terminal 100, stores the data packet 21D in the buffer (Step S14), and transmits a NACK to the base station 900 (Step S15).

When the base station 900 receives the NACK from the mobile terminal 100, the base station 900 retransmits, to the mobile terminal 100, the control packet 22C and the data packet 22D from which bits are punctured that are different from the bits in the data packet 21D (Step S16). When the mobile terminal 100 receives the data packet 22D, the mobile terminal 100 combines the data packet 21D with the data packet 22D (Step S17) and performs the error detection on the combined data packet. In this example, it is assumed that the mobile terminal 100 did not detect an error in the combined data packet. Accordingly, the mobile terminal 100 transmits an ACK to the base station 900 (Step S18).

As described above, because the mobile terminal 100 according to the second embodiment determines whether a data packet is to be transmitted to the mobile terminal 100 even when the mobile terminal 100 performs the receiving process on the data packet that is not to be transmitted to the mobile terminal 100, the mobile terminal 100 does not store the data packet that is not to be transmitted to the mobile terminal 100 in the buffer. Accordingly, the mobile terminal 100 can prevent the situation in which a normal data packet is not received.

### Configuration of the Base Station According to the Second Embodiment

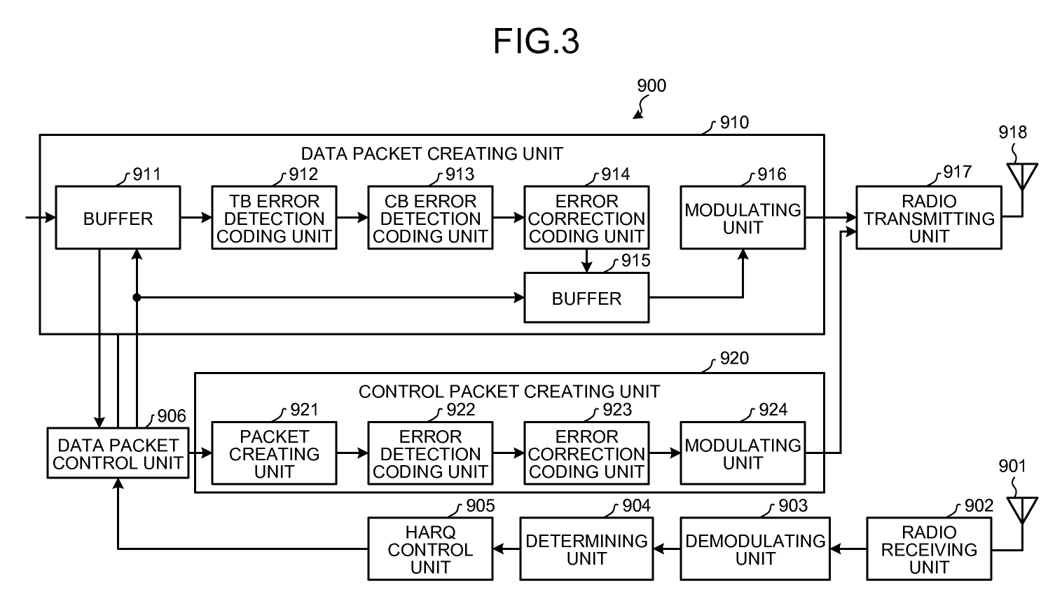

In the following, the configuration of the base station 900 according to the second embodiment will be described with reference to FIG. 3. FIG. 3 is a block diagram illustrating an example configuration of the base station 900 according to the second embodiment. As illustrated in FIG. 3, the base station 900 includes an antenna 901, a radio receiving unit 902, a demodulating unit 903, a determining unit 904, a HARQ control unit 905, and a data packet control unit 906. In the following, a description will be given of a case in which the base station 900 receives a response of an ACK or a NACK transmitted from the mobile terminal 100 after the base station 900 has transmitted a data packet to the mobile terminal 100.

The antenna 901 receives a radio signal from the outside. The radio receiving unit 902 receives the radio signal via the antenna 901. The demodulating unit 903 demodulates the radio signal that is input from the radio receiving unit 902. In this example, the demodulating unit 903 demodulates the radio signal that is a response transmitted from the mobile terminal 100.

On the basis of the modulated data that is input from the demodulating unit 903, the determining unit 904 determines whether the response transmitted from the mobile terminal 100 is an ACK or a NACK. If a response is not transmitted from the mobile terminal 100, the determining unit 904 determines that the response from the mobile terminal 100 is a DTX.

The HARQ control unit 905 determines, on the basis of the determination result obtained by the determining unit 904, whether the data packet is to be retransmitted to the mobile terminal 100 and notifies the data packet control unit 906 of the determination result.

Specifically, if the determining unit 904 determines that the response is an ACK, the HARQ control unit 905 determines that the data packet has been normally received by the mobile terminal 100 and does not notify the data packet control unit 906 of a retransmission request.

In contrast, if the determining unit 904 determines that the response is a NACK, the HARQ control unit 905 determines that the data packet has not been normally received by the mobile terminal 100. Then, the HARQ control unit 905 compares the number of transmissions of the data packet with the maximum number of transmissions that was previously determined. If the number of transmissions is equal to or less than the maximum number of transmissions, the HARQ control unit 905 instructs the data packet control unit 906 to increment the number of transmissions by one and sends a retransmission request. In contrast, if the number of transmissions is equal to or greater than the maximum number of transmissions, the HARQ control unit 905 does not send a retransmission request to the data packet control unit 906.

Furthermore, if the determining unit 904 determines that the response is a DTX, the HARQ control unit 905 determines that the data packet has not been normally received by the mobile terminal 100 and sends a retransmission request to the data packet control unit 906. In contrast, if the response is a DTX, the HARQ control unit 905 does not instruct the data packet control unit 906 to increment the number of transmissions by one. The reason for this is that, if the response is a DTX, it is possible that the mobile terminal 100 does not recognize that the data packet has been transmitted from the base station 900. Accordingly, if the response is a DTX, the HARQ control unit 905 controls the data packet such that the data packet is retransmitted, without incrementing the number of transmissions by one, by cancelling out the previous transmission process.

The data packet control unit 906 controls various kinds of information related to a data packet. Specifically, if the size of data stored in a buffer 911, which will be described later, is equal to or greater than a predetermined size, the data packet control unit 906 instructs the buffer 911 to output the data to a transport block (TB) error detection coding unit 912, which will be described later. At this time, the data packet control unit 906 determines, for example, the size of the data packet or a modulation technique performed on a data packet and notifies a packet creating unit 921 of the determined size of the data packet, the determined modulation technique, and information indicating that the data packet is transmitted for the first time.

Furthermore, if a retransmission request is received from the HARQ control unit 905, the data packet control unit 906 instructs a buffer 915 to retransmit the data packet. At this time, the data packet control unit 906 notifies the packet creating unit 921 of the number of transmissions received from the HARQ control unit 905.

Furthermore, as illustrated in FIG. 3, the base station 900 includes a data packet creating unit 910, a radio transmitting unit 917, an antenna 918, and a control packet creating unit 920. The data packet creating unit 910 includes the buffer 911, the TB error detection coding unit 912, a CB error detection coding unit 913, an error correction coding unit 914, the buffer 915, and a modulating unit 916.

The buffer 911 stores therein data transmitted to the mobile terminal 100. If the buffer 911 is instructed, by the data packet control unit 906, to output data to the TB error detection coding unit 912, the buffer 911 outputs, to the TB error detection coding unit 912, data having a predetermined size that is referred to as a “transport block”. Furthermore, data is stored in the buffer 911 by, for example, an interface unit or a higher-level device, which is not illustrated.

The TB error detection coding unit 912 attaches a CRC to the transport block that is output from the buffer 911. In the following, a CRC attached to the transport block by the TB error detection coding unit 912 may sometimes be referred to as a “TB-CRC”.

The CB error detection coding unit 913 divides the transport block, to which a CRC is attached by the TB error detection coding unit 912, into code blocks that are equivalent in size to that of a code block and attaches a CRC to each of the divided code blocks. In the following, a CRC attached to the code block by the CB error detection coding unit 913 may sometimes be referred to as a “CB-CRC”.

The error correction coding unit 914 performs error correction coding on a code block to which a CRC is attached by the CB error detection coding unit 913 and stores the code block that has been subjected to the error correction coding in the buffer 915.

The buffer 915 stores therein a code block that has been subjected to the error correction coding by the error correction coding unit 914 and outputs the code block to the modulating unit 916. Furthermore, if the buffer 915 is instructed, by the data packet control unit 906, to retransmit the data packet, the buffer 915 outputs, to the modulating unit 916, the code block that is to be retransmitted.

The modulating unit 916 joins code blocks that are output from the buffer 915 and modulates the joined data. Then, the modulating unit 916 outputs the modulated data to the radio transmitting unit 917. The radio transmitting unit 917 performs a process to transmit the data modulated by the modulating unit 916 to the outside via the antenna 918.

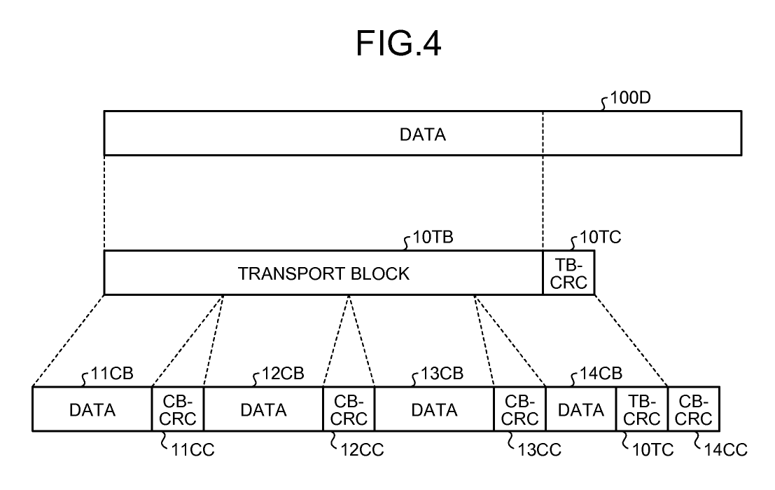

In the following, a data packet creating process performed by the buffer 911, the TB error detection coding unit 912, the CB error detection coding unit 913, and the error correction coding unit 914 will be described with reference to FIG. 4. FIG. 4 is a schematic diagram illustrating a data packet creating process performed by the data packet creating unit 910.

In the example illustrated in FIG. 4, it is assumed that the buffer 911 stores therein data 100D. In such a case, the buffer 911 outputs a transport block 10TB to the TB error detection coding unit 912. Then, the TB error detection coding unit 912 attaches a TB-CRC 10TC to a transport block 10TB. Then, the CB error detection coding unit 913 divides the transport block 10TB and the TB-CRC 10TC into code blocks that are equivalent in size to that of a code block and attaches CB-CRCs 11CC, 12CC, 13CC, and 14CC to the divided code blocks 11CB, 12CB, 13CB, and 14CB, respectively.

A description will be given here by referring back to FIG. 3. The control packet creating unit 920 includes the packet creating unit 921, an error detection coding unit 922, an error correction coding unit 923, and a modulating unit 924. The packet creating unit 921 creates a control packet on the basis of, for example, the size of a data packet or a modulation technique performed on a data packet received from the data packet control unit 906.

The error detection coding unit 922 attaches a CRC to the control packet created by the packet creating unit 921. The error correction coding unit 923 performs error correction coding on a control packet to which a CRC is attached by the error detection coding unit 922. The modulating unit 924 modulates a control packet subjected to the error correction coding performed by the error correction coding unit 923 and transmits the modulated control packet to the outside via the radio transmitting unit 917 and the antenna 918.

### Configuration of the Mobile Terminal According to the Second Embodiment

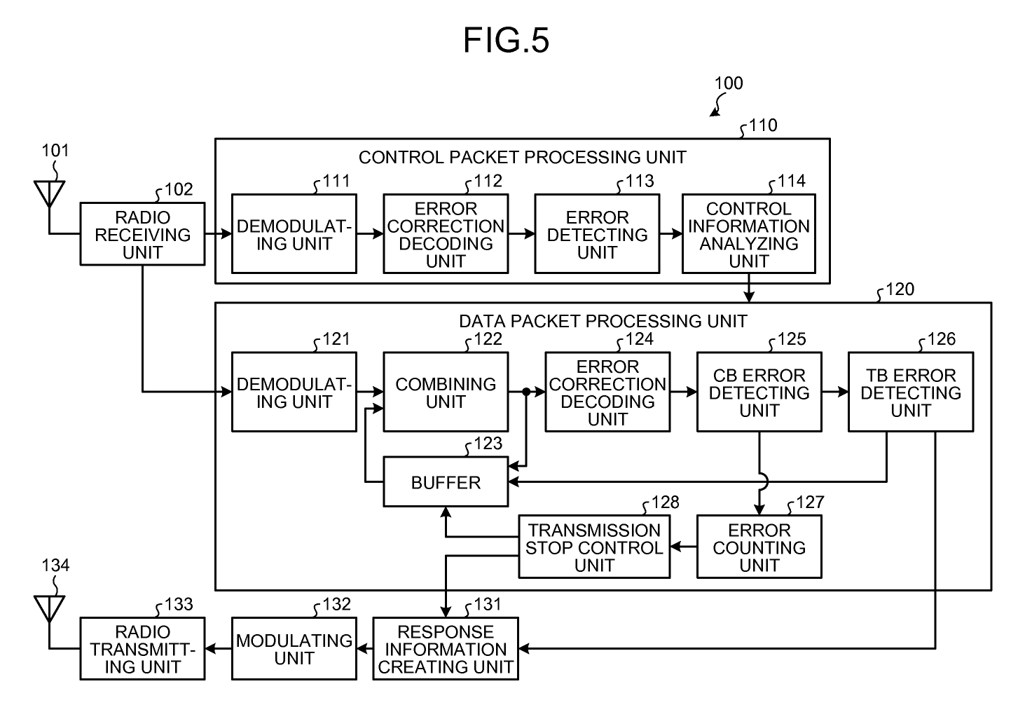

In the following, the configuration of the mobile terminal 100 according to the second embodiment will be described with reference to FIG. 5. FIG. 5 is a block diagram illustrating an example configuration of the mobile terminal 100 according to the second embodiment. As illustrated in FIG. 5, the mobile terminal 100 according to the second embodiment includes an antenna 101, a radio receiving unit 102, a control packet processing unit 110, a data packet processing unit 120, a response information creating unit 131, a modulating unit 132, a radio transmitting unit 133, and an antenna 134.

The antenna 101 receives a radio signal from the outside. The radio receiving unit 102 receives a radio signal via the antenna 101. The control packet processing unit 110 performs a receiving process on a control packet received by the radio receiving unit 102. As illustrated in FIG. 5, the control packet processing unit 110 described above includes a demodulating unit 111, an error correction decoding unit 112, an error detecting unit 113, and a control information analyzing unit 114.

The demodulating unit 111 demodulates a control packet received by the radio receiving unit 102. The error correction decoding unit 112 performs error correction decoding on the control packet that is demodulated by the demodulating unit 111. The error detecting unit 113 performs error detection on the control packet subjected to the error correction decoding performed by the error correction decoding unit 112.

The control information analyzing unit 114 analyzes the control packet subjected to the error detection performed by the error detecting unit 113. For example, by analyzing the control packet, the control information analyzing unit 114 acquires, for example, the frequency band of a data packet transmitted to the mobile terminal 100, the timing at which a data packet is transmitted to the mobile terminal 100, the size of a data packet, a modulation technique performed on a data packet, or the number of transmissions. Then, the control information analyzing unit 114 notifies the data packet processing unit 120 of the acquired various kinds of information.

The data packet processing unit 120 performs the receiving process on the data packet received by the radio receiving unit 102. As illustrated in FIG. 5, the data packet processing unit 120 includes a demodulating unit 121, a combining unit 122, a buffer 123, an error correction decoding unit 124, a CB error detecting unit 125, a TB error detecting unit 126, an error counting unit 127, and a transmission stop control unit 128. The demodulating unit 121 demodulates the data packet received by the radio receiving unit 102.

If the data packet demodulated by the demodulating unit 121 is not a retransmitted data packet, the combining unit 122 stores the data packet in the buffer 123 and outputs it to the error correction decoding unit 124. In contrast, if the data packet demodulated by the demodulating unit 121 is a retransmitted data packet, the combining unit 122 combines the data packet demodulated by the demodulating unit 121 with the data packet stored in the buffer 123. At this time, the combining unit 122 acquires, from the buffer 123, for example, a data packet that has the same HARQ process number and the same new data indicator as that demodulated by the demodulating unit 121. Then, the combining unit 122 combines the data packet demodulated by the demodulating unit 121 with the data packet acquired from the buffer 123. Then, the combining unit 122 stores the combined data packet in the buffer 123 and outputs it to the error correction decoding unit 124. The combining unit 122 corresponds to the combining unit 8 illustrated in FIG. 1. The buffer 123 corresponds to the storing unit 7 illustrated in FIG. 1.

The error correction decoding unit 124 performs error correction decoding on a data packet that is output from the combining unit 122. The CB error detecting unit 125 divides the data packet subjected to the error correction decoding by the error correction decoding unit 124 into code blocks that are equivalent in size to that of a code block and performs error detection on each of the divided code blocks. The CB error detecting unit 125 corresponds to the second detecting unit 3 illustrated in FIG. 1.

The TB error detecting unit 126 creates a data packet having the size of a transport block by joining each of the code blocks in which an error has been detected by the CB error detecting unit 125 and performs error detection on the created data packet having the size of a transport block. Then, the TB error detecting unit 126 notifies the response information creating unit 131 of the error detection result. If an error has not been detected in a data packet, the TB error detecting unit 126 deletes the data packet in which an error has not been detected from the buffer 123. The TB error detecting unit 126 corresponds to the first detecting unit 2 illustrated in FIG. 1.

The error counting unit 127 counts the number of code blocks in which an error has been detected by the CB error detecting unit 125. Then, the error counting unit 127 notifies the transmission stop control unit 128 of the count result. The error counting unit 127 corresponds to the counting unit 4 illustrated in FIG. 1.

The transmission stop control unit 128 controls, on the basis of the number of code blocks counted by the error counting unit 127, a response information creating process performed by the response information creating unit 131. Specifically, if the number of code blocks counted by the error counting unit 127 is less than a predetermined threshold, the transmission stop control unit 128 does not instruct the response information creating unit 131 to do anything.

In contrast, if the number of code blocks counted by the error counting unit 127 is equal to or greater than a predetermined threshold, the transmission stop control unit 128 instructs the response information creating unit 131 to allow the mobile terminal 100 to enter the DTX state, in which neither an ACK nor a NACK are transmitted to the base station 900. If the number of code blocks counted by the error counting unit 127 is equal to or greater than a predetermined threshold, the transmission stop control unit 128 deletes a data packet including the subject code block from the buffer 123.

The response information creating unit 131 creates response information on the basis of the error detection result obtained by the TB error detecting unit 126 and the instruction from the transmission stop control unit 128. Specifically, if an error is not detected in a transport block by the TB error detecting unit 126, the response information creating unit 131 creates an ACK as response information.

In contrast, if an error is detected in the transport block by the TB error detecting unit 126, the response information creating unit 131 creates response information in accordance with an instruction received from the transmission stop control unit 128. Specifically, if the response information creating unit 131 does not receive an instruction indicating that the mobile terminal 100 enters the DTX state from the transmission stop control unit 128, the response information creating unit 131 creates a NACK as response information. In contrast, if the response information creating unit 131 receives an instruction indicating that the mobile terminal 100 enters the DTX state from the transmission stop control unit 128, the response information creating unit 131 does not create response information. The transmission stop control unit 128 and the response information creating unit 131 correspond to the determining unit 5 and the retransmission requesting unit 6, respectively, illustrated in FIG. 1.

The modulating unit 132 modulates the response information created by the response information creating unit 131. The radio transmitting unit 133 transmits the packet that has been modulated by the modulating unit 132 to the outside via the antenna 134.

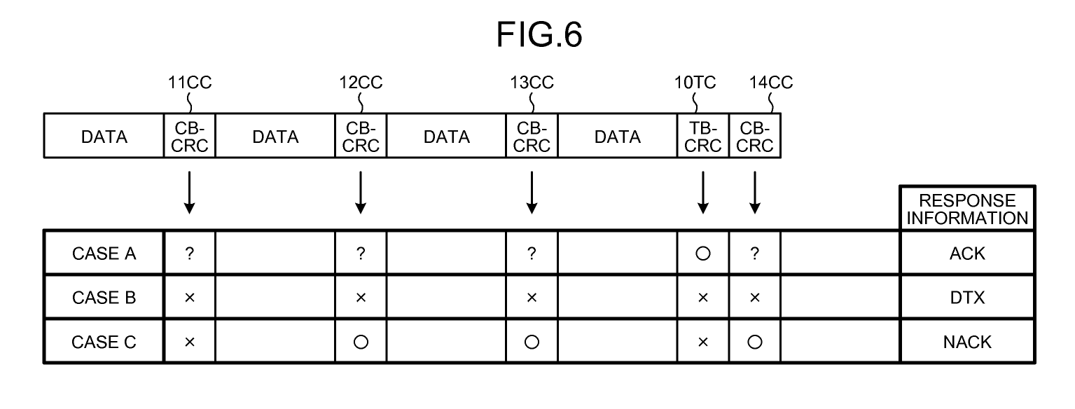

In the following, a process performed by the CB error detecting unit 125, the TB error detecting unit 126, the transmission stop control unit 128, and the response information creating unit 131 will be described with reference to FIG. 6. FIG. 6 is a schematic diagram illustrating an example of a response information creating process performed by the mobile terminal 100 according to the second embodiment. FIG. 6 illustrates an example in which four code blocks are included in a single transport block. The TB-CRC 10TC is attached to the single transport block. Furthermore, the CB-CRC 11CC, the CB-CRC 12CC, the CB-CRC 13CC, and the CB-CRC 14CC are attached to the respective four code blocks.

Furthermore, in the example illustrated in FIG. 6, a circle indicated below the TB-CRC 10TC indicates a case in which an error is not detected in a transport block by the TB error detecting unit 126. Furthermore, a cross indicated below the TB-CRC 10TC indicates a case in which an error is detected in a transport block by the TB error detecting unit 126. Furthermore, if a circle is indicated below the CB-CRC 11CC, the CB-CRC 12CC, the CB-CRC 13CC, or the CB-CRC 14CC, this indicates a case in which an error is not detected in a corresponding code block by the CB error detecting unit 125. Furthermore, if a cross is indicated below the CB-CRC 11CC, the CB-CRC 12CC, the CB-CRC 13CC, or the CB-CRC 14CC, this indicates a case in which an error is detected in a corresponding code block by the CB error detecting unit 125.

In “case A” illustrated in the example in FIG. 6, the TB error detecting unit 126 did not detect an error in the transport block at the time of error detection performed by using the TB-CRC 10TC. In such a case, because retransmission of the data packet is not requested, the transmission stop control unit 128 does not instruct the response information creating unit 131 to do anything. Accordingly, the response information creating unit 131 creates an ACK.

In “case B” illustrated in the example in FIG. 6, the TB error detecting unit 126 detects an error in the transport block at the time of error detection performed by using the TB-CRC 10TC. Furthermore, the CB error detecting unit 125 detects an error in all of the four code blocks. In such a case, it is possible that the data packet is not to be transmitted to the mobile terminal 100. Specifically, the probability that an error is detected in all of the code blocks contained in the data packet to be transmitted to the mobile terminal 100 is low. Accordingly, the transmission stop control unit 128 determines that the data packet is not to be transmitted to the mobile terminal 100, deletes the data packet from the buffer 123, and instructs the response information creating unit 131 to allow the mobile terminal 100 to enter the DTX state.

In “case C” illustrated in the example in FIG. 6, the TB error detecting unit 126 detects an error in the transport block at the time of error detection performed by using the TB-CRC 10TC. Furthermore, the CB error detecting unit 125 detects an error in two code blocks out of four code blocks. In such a case, it is possible that the data packet is to be transmitted to the mobile terminal 100 but an error is contained in the data packet. Accordingly, the transmission stop control unit 128 determines that the data packet is to be transmitted to the mobile terminal 100 and thus does not instruct the response information creating unit 131 to do anything. Specifically, the response information creating unit 131 creates a NACK as response information and transmits the created response information to the base station 900.

### Flow of a Process Performed by the Mobile Terminal According to the Second Embodiment

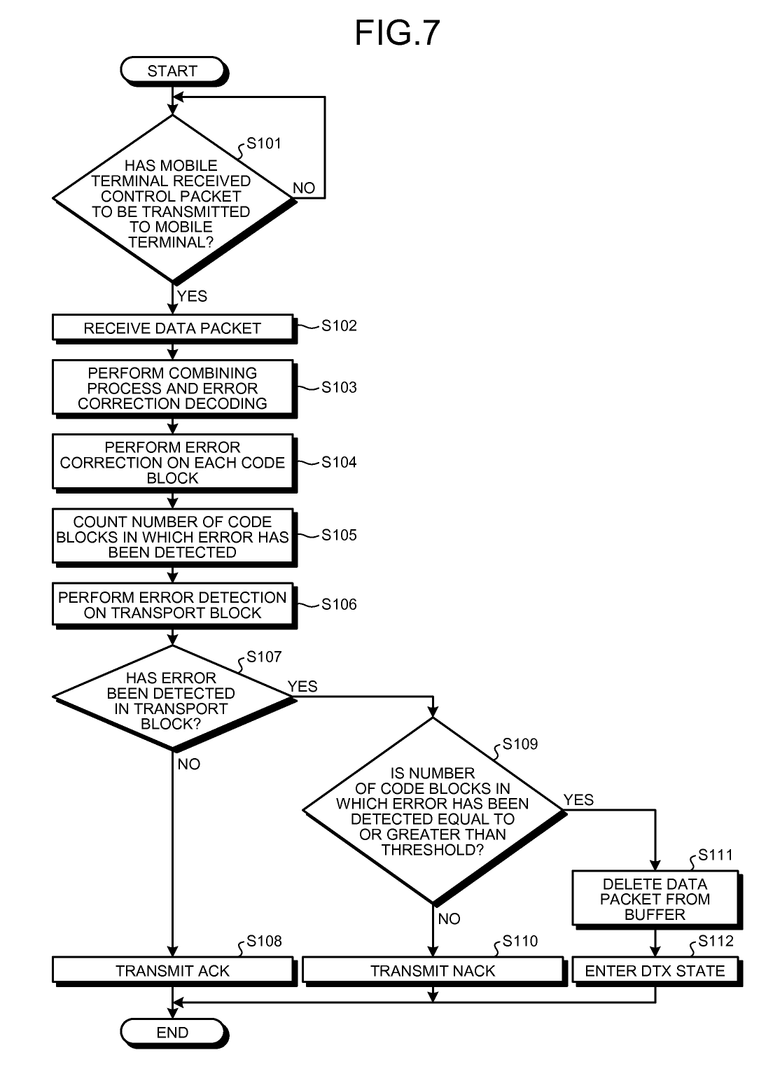

In the following, the flow of a process performed by the mobile terminal according to the second embodiment will be described with reference to FIG. 7. FIG. 7 is a flowchart illustrating a process performed by the mobile terminal 100 according to the second embodiment. As illustrated in FIG. 7, when the radio receiving unit 102 in the mobile terminal 100 receives a control packet that is to be transmitted to the mobile terminal 100 (Yes at Step S101), the radio receiving unit 102 receives a data packet to be transmitted to the mobile terminal 100 on the basis of the control packet (Step S102).

Then, the combining unit 122 performs a combining process on the received data packet and the error correction decoding unit 124 performs error correction decoding (Step S103). Subsequently, the CB error detecting unit 125 divides the data packet subjected to the error correction decoding performed by the error correction decoding unit 124 into code blocks that are equivalent in size to that of a code block and performs error detection on each of the divided code blocks (Step S104). At this time, the error counting unit 127 counts the number of code blocks in each of which an error has been detected by the CB error detecting unit 125 (Step S105).

Subsequently, the TB error detecting unit 126 creates a data packet having the size of a transport block by joining the code blocks in each of which an error has been detected by the CB error detecting unit 125 and performs error detection on the created transport block (Step S106).

Subsequently, if an error is not detected in the transport block by the TB error detecting unit 126 (No at Step S107), the response information creating unit 131 creates an ACK and transmits it to the outside (Step S108).

In contrast, if an error is detected in the transport block by the TB error detecting unit 126 (Yes at Step S107), the response information creating unit 131 creates response information in accordance with an instruction from the transmission stop control unit 128.

Specifically, if the number of code blocks counted by the error counting unit 127 is less than a predetermined threshold (No at Step S109), the transmission stop control unit 128 does not instruct the response information creating unit 131 to do anything. In such a case, the response information creating unit 131 creates a NACK and transmits it to the outside (Step S110).

In contrast, if the number of code blocks counted by the error counting unit 127 is equal to or greater than a predetermined threshold (Yes at Step S109), the transmission stop control unit 128 deletes the data packet from the buffer 123 (Step S111). At this time, the transmission stop control unit 128 instructs the response information creating unit 131 to enter the DTX state. In such a case, the response information creating unit 131 enters the DTX state in which an ACK nor a NACK is transmitted (Step S112).

### Advantage of the Second Embodiment

As described above, if the mobile terminal 100 according to the second embodiment receives a data packet having the size of a transport block from the base station 900, the mobile terminal 100 counts the number of code blocks in which an error has been detected from among the code blocks contained in the data packet. Then, even when the mobile terminal 100 detects an error in the data packet having the size of the transport block, if the number of code blocks in which an error has been detected is equal to or greater than a predetermined threshold, the mobile terminal 100 determines that the received data packet is not to be transmitted to the mobile terminal 100 and discards it. Then, the mobile terminal 100 does not transmit response information on the received data packet to the base station 900.

Specifically, the mobile terminal 100 according to the second embodiment does not store a data packet in the buffer 123 that retains data packets to be combined even in a case in which the receiving process is erroneously performed on a data packet that is not to be transmitted. Accordingly, the mobile terminal 100 can prevent the situation in which a normal data packet is not received. For example, even when the mobile terminal 100 receives a data packet that is not to be transmitted to the mobile terminal 100 on the basis of a control packet that is not to be transmitted to the mobile terminal 100, the mobile terminal 100 can prevent the situation in which a normal data packet is not received.

### [c] Third Embodiment

In the following, in a third embodiment, a description will be given of a case in which the mobile terminal 100 according to the second embodiment is used in LTE and Long Term Evolution Advanced (LTE-A).

### Example of the Frame Configuration

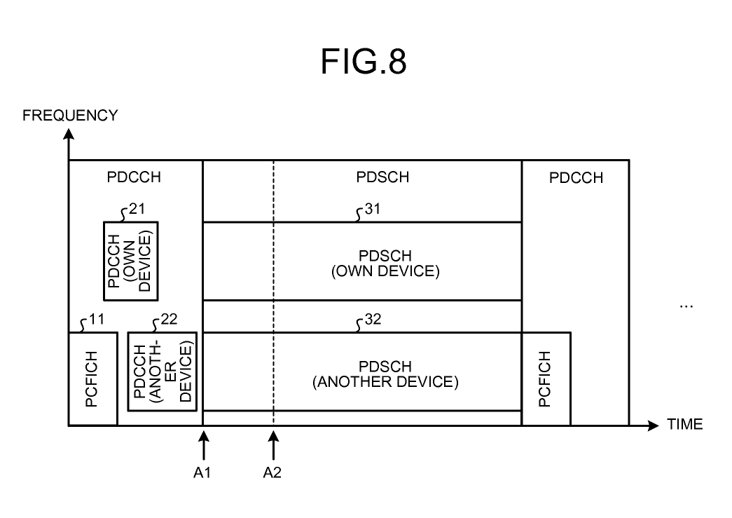

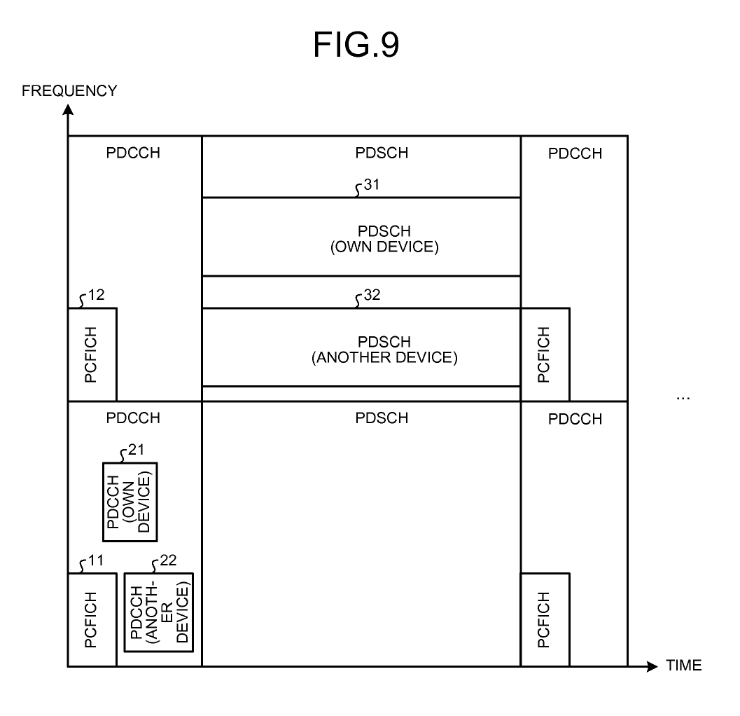

First, a frame configuration in the downlink used in LTE and LTE-A will be described with reference to FIGS. 8 and 9. FIG. 8 is a schematic diagram illustrating an example of the frame configuration in a downlink of LTE. As illustrated in FIG. 8, a physical control format indicator channel (PCFICH), PDCCH, and a physical downlink shared channel (PDSCH) are included in a downlink frame that is used in LTE.

The PCFICH indicates, for example, the boundary between the PDCCH and the PDSCH. In the example illustrated in FIG. 8, the PCFICH 11 represents “A1” that is the boundary between the PDCCH and the PDSCH.

The PDCCH is a region in which a control packet is contained. For example, the PDCCH contains control packets used by multiple users. In the example illustrated in FIG. 8, it is assumed that the PDCCH 21 indicates a control packet to be transmitted to a mobile terminal 200 according to the third embodiment and that a PDCCH 22 indicates a control packet to be transmitted to a mobile terminal other than the mobile terminal 200.

The PDSCH is a region in which a data packet is contained. For example, the PDSCH contains data packets used by multiple users. In the example illustrated in FIG. 8, a PDSCH 31 indicates a data packet to be transmitted to the mobile terminal 200 according to the third embodiment. A PDSCH 32 indicates a data packet to be transmitted to a mobile terminal other than the mobile terminal 200.

Specifically, in the example illustrated in FIG. 8, the mobile terminal 200 according to the third embodiment analyzes the PCFICH 11, acquires information indicating the boundary between the PDCCH and the PDSCH, and receives the PDCCH 21 that is to be transmitted to the mobile terminal 200. For example, the mobile terminal 200 performs error detection on each PDCCH by using the CRC contained in the PDCCH. Then, the mobile terminal 200 determines that the PDCCH in which an error has not been detected is the PDCCH to be transmitted to the mobile terminal 200. Then, the mobile terminal 200 transmits the PDSCH 31 that is to be transmitted to the mobile terminal 200 on the basis of the PDCCH 21 that is transmitted to the mobile terminal 200.

FIG. 9 is a schematic diagram illustrating an example of the frame configuration in a downlink of LTE-A. As illustrated in FIG. 9, in the downlink frame used in LTE-A, PCFICH, PDCCH, and PDSCH are contained in different frequency bands. Furthermore, in a frame in LTE-A, PDCCH and PDSCH that are transmitted to a single user may sometimes mapped onto different frequency bands.

In the example illustrated in FIG. 9, it is assumed that the PDCCH 21 represents a control packet to be transmitted to the mobile terminal 200. Furthermore, it is assumed that the PDSCH 31 represents a data packet to be transmitted to the mobile terminal 200. In this way, in a frame in LTE-A, the PDCCH 21 and the PDSCH 31 to be transmitted to the mobile terminal 200 used by a single user may sometimes mapped onto different frequency bands.

Specifically, in the example illustrated in FIG. 9, the mobile terminal 200 according to the third embodiment analyzes the PCFICH 11, acquires information indicating the boundary between PDCCH and PDSCH, and receives the PDCCH 21 to be transmitted to the mobile terminal 200. Then, the mobile terminal 200 analyzes the PCFICH 12 on the basis of the PDCCH 21 to be transmitted to the mobile terminal 200, acquires information indicating the boundary between PDCCH and PDSCH, and receives the PDSCH 31 that is to be transmitted to the mobile terminal 200.

### Configuration of a Base Station According to the Third Embodiment

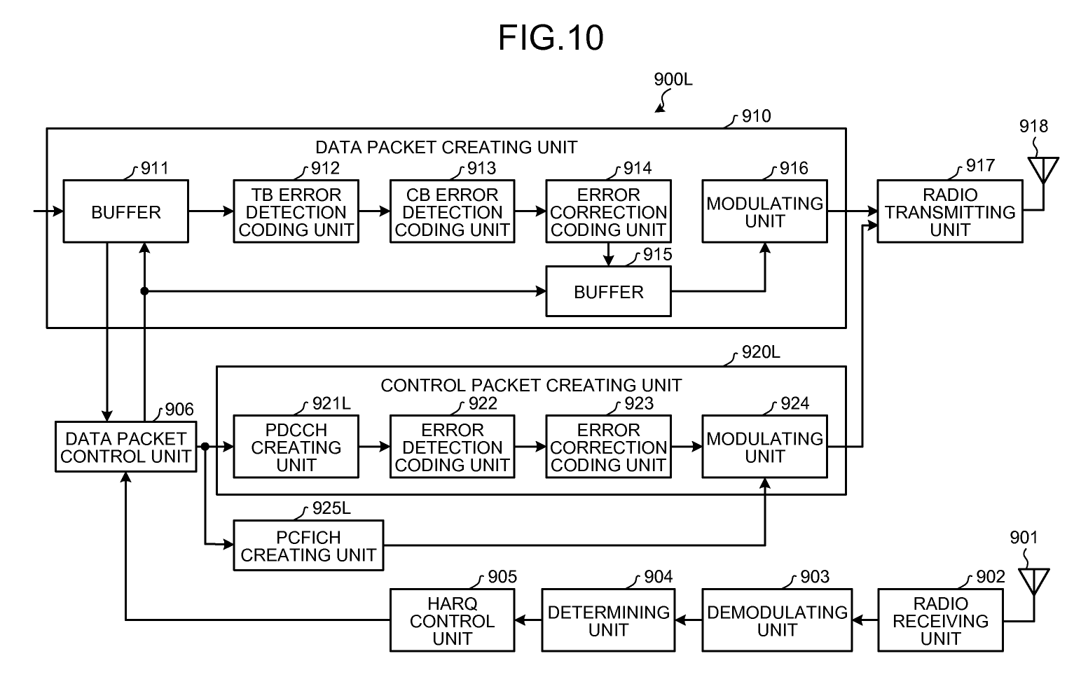

In the following, the configuration of a base station 900L according to the third embodiment will be described with reference to FIG. 10. FIG. 10 is a block diagram illustrating an example configuration of the base station 900L according to a third embodiment. In the following, components having the same function as those described above are assigned the same reference numerals; therefore, a description thereof is omitted.

As illustrated in FIG. 10, the base station 900L includes a PCFICH creating unit 925L. The PCFICH creating unit 925L creates a PCFICH on the basis of various kinds of information received from the data packet control unit 906. The PCFICH created by the PCFICH creating unit 925L is transmitted to the outside via the radio transmitting unit 917 and the antenna 918.

Furthermore, as illustrated in FIG. 10, a control packet creating unit 920L in the base station 900L includes a PDCCH creating unit 921L. The PDCCH creating unit 921L creates a PDCCH on the basis of the size of a data packet or a modulation technique performed on data packet received from the data packet control unit 906. The PDCCH created by the PDCCH creating unit 921L is transmitted to the outside via the error detection coding unit 922, the error correction coding unit 923, the modulating unit 924, the radio transmitting unit 917, and the antenna 918.

### Configuration of the Mobile Terminal According to the Third Embodiment

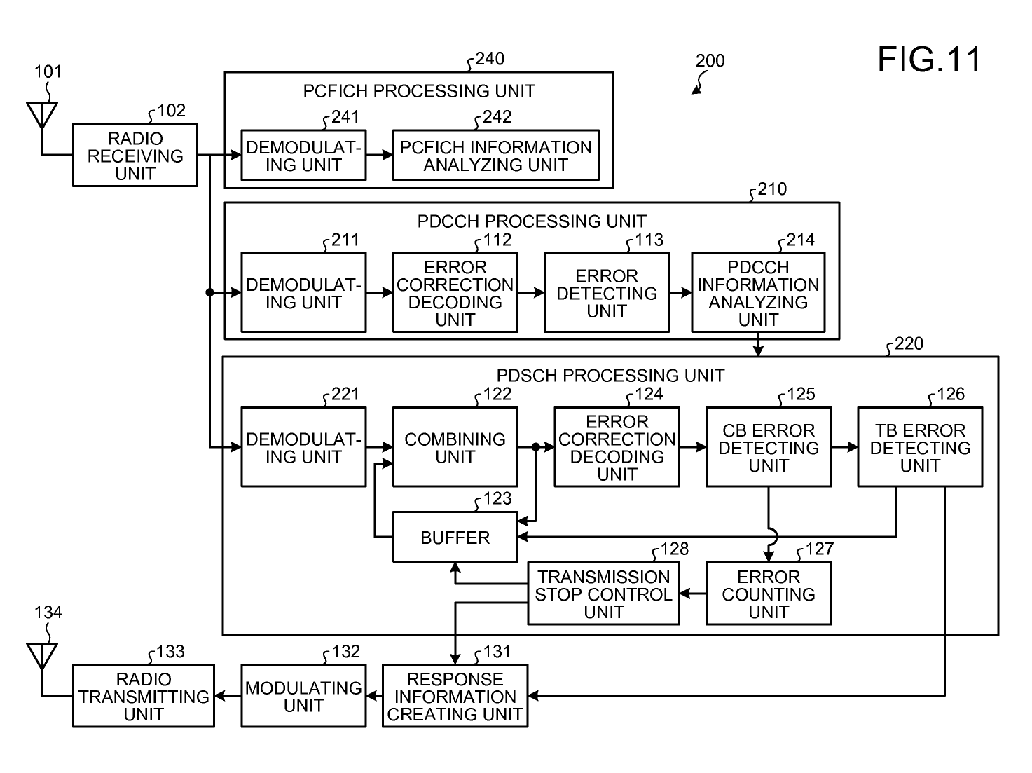

In the following, the configuration of the mobile terminal 200 according to the third embodiment will be described with reference to FIG. 11. FIG. 11 is a block diagram illustrating an example configuration of the mobile terminal 200 according to the third embodiment. As illustrated in FIG. 11, the mobile terminal 200 includes a PCFICH processing unit 240, a PDCCH processing unit 210, and a PDSCH processing unit 220.

The PCFICH processing unit 240 includes a demodulating unit 241 and a PCFICH information analyzing unit 242. The demodulating unit 241 demodulates a PCFICH received by the radio receiving unit 102. The PCFICH information analyzing unit 242 analyzes the PCFICH demodulated by the demodulating unit 241. For example, by analyzing the PCFICH, the PCFICH information analyzing unit 242 acquires information on the boundary between the PDCCH and the PDSCH. Then, the PCFICH information analyzing unit 242 notifies the PDCCH processing unit 210 of the analysis result of the PCFICH.

The PDCCH processing unit 210 includes a demodulating unit 211 and a PDCCH information analyzing unit 214. The demodulating unit 211 demodulates the PDCCH received by the radio receiving unit 102. The PDCCH demodulated by the demodulating unit 211 is output to the PDCCH information analyzing unit 214 via the error correction decoding unit 112 and the error detecting unit 113.

The PDCCH information analyzing unit 214 analyzes a PDCCH that is input from the error detecting unit 113. For example, by analyzing the PDCCH, the PDCCH information analyzing unit 214 acquires, for example, the frequency band of a data packet transmitted to the mobile terminal 200, the timing at which a data packet is transmitted to the mobile terminal, the size of a data packet, a modulation technique performed on a data packet, and the number of transmissions. Then, the PDCCH information analyzing unit 214 notifies the PDSCH processing unit 220 of the acquired various kinds of information.

The PDSCH processing unit 220 includes a demodulating unit 221. The demodulating unit 221 demodulates the PDSCH received by the radio receiving unit 102. The PDSCH demodulated by the demodulating unit 221 is subjected to various processes by the combining unit 122, the error correction decoding unit 124, the CB error detecting unit 125, the TB error detecting unit 126, the error counting unit 127, and the transmission stop control unit 128.

### Advantage of the Third Embodiment

As described above, even when the mobile terminal 200 conforming to LTE or LTE-A detects an error in a transport block, the mobile terminal 200 discards the received data packet if the number of code blocks in which an error has been detected is equal to or greater than a predetermined threshold. Then, the mobile terminal 200 does not transmit response information on the received data packet to the base station 900. Specifically, even in a case in which the mobile terminal 200 according to the third embodiment erroneously performs the receiving process on a data packet that is not to be transmitted to the mobile terminal 200, the mobile terminal 100 can prevent the situation in which a normal data packet is not received.

In the following, a description will be given of an example with reference to FIGS. 8 and 9 in which the mobile terminal 200 receives an abnormal PDSCH. For example, in the example illustrated in FIG. 8, if the mobile terminal 200 performs error detection by using a CRC contained in the PDCCH 22, the mobile terminal 200 sometimes does not detect an error in the PDCCH 22. In such a case, the mobile terminal 200 erroneously receives the PDSCH 32 that is not to be transmitted to the mobile terminal 200 on the basis of the PDCCH 22 that is not to be transmitted to the mobile terminal 200.

In such a case, the TB error detecting unit 126 in the mobile terminal 200 detects an error in the PDSCH 32 that is not to be transmitted to the mobile terminal 200. Furthermore, the CB error detecting unit 125 detects an error in all of the code blocks contained in the PDSCH 32 that is not to be transmitted to the mobile terminal 200. Accordingly, the transmission stop control unit 128 deletes the PDSCH 32 from the buffer 123 and controls the base station 900 such that the base station 900 does not transmit the response information (ACK/NACK). Accordingly, the mobile terminal 200 can prevent the situation in which a normal data packet is not received without detecting an error in the PDCCH 22 that is not transmitted to the mobile terminal 200 even when the mobile terminal 200 receives the PDSCH 32 that is not to be transmitted to the mobile terminal 200.

Furthermore, in the example illustrated in FIG. 8, the mobile terminal 200 may sometimes erroneously analyze the PCFICH 11. For example, after analyzing the PCFICH 11, the mobile terminal 200 may sometimes acquire “A2” as the boundary between the PDCCH and the PDSCH. In such a case, the mobile terminal 200 does not normally the PDSCH 31 on the basis of the PDCCH 21 that is to be transmitted to the mobile terminal 200. Specifically, the mobile terminal 200 receives the PDSCH 31 from which a top region indicated between “A1” and “A2” is excluded.

In such a case, the TB error detecting unit 126 in the mobile terminal 200 detects an error in the PDSCH that does not contain the top region indicated between “A1” and “A2”. Furthermore, the CB error detecting unit 125 divides PDSCH into code blocks, from the top, that are equivalent in size to that of a code block and performs error detection on the divided code blocks. Because the PDSCH that is to be subjected to error detection does not contain the top region when compared with the normal PDSCH 31, the CB error detecting unit 125 detects an error in all of the code blocks. Accordingly, the transmission stop control unit 128 deletes the received PDSCH from the buffer 123 and controls the base station 900 such that the base station 900 does not transmit the response information (ACK/NACK). Accordingly, even when the mobile terminal 200 receives an abnormal PDSCH due to erroneous analysis of the PCFICH, the mobile terminal 200 can prevent the situation in which a normal data packet is not received.

Furthermore, in the example illustrated in FIG. 9, similarly to the example illustrated in FIG. 8, the mobile terminal 200 sometimes does not detect an error in the PDCCH 22 when the mobile terminal 200 performs error detection by using a CRC contained in the PDCCH 22. In such a case, the mobile terminal 200 erroneously receives the PDSCH 32 that is not to be transmitted to the mobile terminal 200 on the basis of the PDCCH 22 that is not to be transmitted to the mobile terminal 200. However, similarly to the example illustrated in FIG. 8, the mobile terminal 200 can prevent the situation in which a normal data packet is not received.

Furthermore, in the example illustrated in FIG. 9, the mobile terminal 200 may sometimes erroneously analyze the PCFICH 12. In such a case, the mobile terminal 200 does not normally receive the PDSCH 31 on the basis of the PDCCH 21 that is to be transmitted to the mobile terminal 200; however, similarly to the example illustrated in FIG. 8, the mobile terminal 200 can prevent the situation in which a normal data packet is not received.

### [d] Fourth Embodiment

The receiving apparatus and the units disclosed in the present application can be implemented as various kinds of embodiments other than the embodiments described above. Accordingly, in a fourth embodiment, another embodiment of the receiving apparatus and the units disclosed in the present application will be described.

### Threshold (1)

In the first to the third embodiments, a description has been given of an example in which it is determined whether the number of blocks in which an error has been detected is less than a predetermined threshold; however, the configuration is not limited thereto. For example, when N represents the number of blocks in a transport block and M represents the number of blocks in which an error has been detected, the receiving apparatus 1 or the mobile terminal 100 or 200 may also determine whether the ratio of the number of blocks M to the number of blocks N is less than a predetermined threshold.

For example, it is assumed that a threshold is “80%”. Furthermore, it is assumed that the number of blocks N in a transport block is 10 i.e., N=“10” and the number of blocks M in which an error is detected is nine, i.e., M=“9”. In such a case, because the ratio of the number of blocks M “9” to that of blocks N “10”, i.e., “90%”, is equal to or greater than the predetermined threshold “80%”, the receiving apparatus 1 or the mobile terminal 100 or 200 discards the received data packet and enters the DTX state. Furthermore, for example, it is assumed that the number of blocks N in a transport block is 10, i.e., N=“10”, and the number of blocks M in which an error has been detected is seven, i.e., M=“7”. In such a case, because the ratio of the number of blocks M “7” to that of blocks N “10”, i.e., “70%”, is less than the predetermined threshold “80%”, the receiving apparatus 1 or the mobile terminal 100 or 200 stores the received data packet in the buffer and sends a retransmission request.

### Threshold (2)

Furthermore, the receiving apparatus 1 or the mobile terminal 100 or 200 may also change a threshold in accordance with the number of blocks N in a transport block. For example, if the number of blocks N in a transport block is four, i.e., N=“4”, the receiving apparatus 1 or the mobile terminal 100 or 200 may also use a threshold “4”, and, if the number of blocks N in a transport block is 10, i.e., N=“10”, the receiving apparatus 1 or the mobile terminal 100 or 200 may also use a threshold “9”.

### Operation Condition

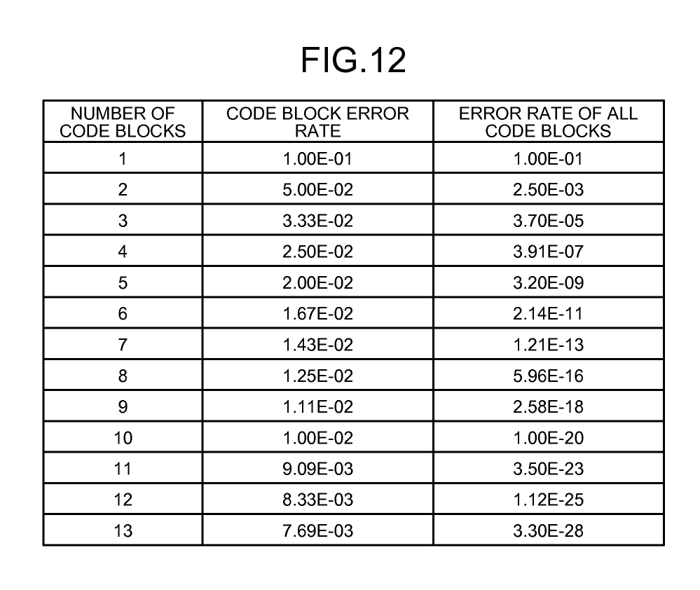

If the number of code blocks contained in the data packet received from the base station is equal to or greater than a predetermined threshold, the receiving apparatus and the mobile terminal according to the first to the third embodiments described above may also determine whether response information is to be transmitted by counting the number of code blocks in which an error has been detected. In the following, such a case will be specifically described reference to FIG. 12. FIG. 12 is a schematic diagram illustrating an example of the error rate of code blocks.

The “number of code blocks” illustrated in FIG. 12 indicates the number of code blocks contained in a transport block. The “code block error rate” illustrated in FIG. 12 indicates the probability with which an error will be detected in a single code block out of code blocks contained in the transport block. The “error rate of all code blocks” illustrated in FIG. 12 indicates the probability with which an error will be detected in all of the code blocks contained in the transport block.

First, a 16-bit CRC is usually attached to a control packet that corresponds to the PDCCH. Accordingly, the mobile terminal may sometimes determine, with the probability of about “½¹⁶“=”1.50E−5 (0.000015 . . . )”, that the PDCCH is to be transmitted to the mobile terminal even though the PDCCH is not to be transmitted to the mobile terminal. Furthermore, an error is usually detected in a transport block with the probability of about “1.00E−1 (0.1 . . . )”.

As in the example illustrated in FIG. 12, if the “number of code blocks” is “1”, the “code block error rate” and the “error rate of all code blocks” is about “1.00E−1”, which is similar to the error rate of the transport block. This is because, if the “number of code blocks” is “1”, the transport block and the code block have almost the same data. Accordingly, if the “number of code blocks” is “1”, the mobile terminal does not always determine, on the basis of the number of code blocks in which an error has been detected, whether a transport block is to be transmitted to the mobile terminal.

Furthermore, in the example illustrated in FIG. 12, if the “number of code blocks” is “2”, the “code block error rate” is about “5.00E−02” and the “error rate of all code blocks” is “2.50E−03”. Specifically, if the “number of code blocks” is “2”, the error rate of all code blocks of “2.50E−03” is higher than the probability “1.50E−5” with which the mobile terminal erroneously detects a control packet. Accordingly, if the “number of code blocks” is “2”, the mobile terminal does not always determine, on the basis of the number of code blocks in which an error has been detected, whether a transport block is to be transmitted to the mobile terminal. For the same reason, if the “number of code blocks” is “3”, the mobile terminal does not always determine, on the basis of the number of code blocks in which an error has been detected, whether a transport block is to be transmitted to the mobile terminal. Accordingly, if the “number of code blocks” is between “1” and “3”, the mobile terminal does not need to determine whether a transport block is to be transmitted to the mobile terminal.

In contrast, as illustrated in the example in FIG. 12, if the “number of code blocks” is “4”, the “code block error rate” is about “2.50E−02” and the “error rate of all code blocks” is “3.91E−07”. Specifically, if the “number of code blocks” is “4”, the error rate of all code blocks “3.91E−07” is lower than the probability “1.5E−5” in which the mobile terminal erroneously detects a control packet. Consequently, if the “number of code blocks” is “4”, when the mobile terminal detects, for example, an error in all of the code blocks contained in the transport block, it is possible to judge that the mobile terminal erroneously receives a control packet that is not to be transmitted to the mobile terminal. For the same reason, if the “number of code blocks” is equal to or greater than “5”, the mobile terminal can determine, on the basis of the number of code blocks in which an error has been detected, whether the transport block is to be transmitted to the mobile terminal.

As described above, in the example illustrated in FIG. 12, if the “number of code blocks” is equal to or greater than “4”, the mobile terminal or the like described in the first to the third embodiments can determine, on the basis of the number of code blocks in which an error has been determined, whether a transport block is to be transmitted to the mobile terminal or the like. Accordingly, if the number of code blocks contained in a transport block is equal to or greater than a predetermined threshold (“4” in the example illustrated in FIG. 12), the receiving apparatus or the mobile terminal described in the first to the third embodiments may also determine whether response information is to be transmitted by counting the number of code blocks in which an error has been detected. In the following, such a case will be specifically described with reference to FIG. 5.

The control information analyzing unit 114 illustrated in FIG. 5 can acquire the number of code blocks included in a transport block by analyzing a control packet. Then, the control information analyzing unit 114 notifies the data packet processing unit 120 of the number of acquired code blocks.

If the number of code blocks notified from the control information analyzing unit 114 is equal to or greater than a predetermined threshold (“4” illustrated in FIG. 12), the error counting unit 127 in the data packet processing unit 120 counts the number of code blocks in which an error has been detected by the CB error detecting unit 125. Then, if the number of code blocks notified from the control information analyzing unit 114 is equal to or greater than a predetermined threshold, the transmission stop control unit 128 controls, on the basis of the count result obtained by the error counting unit 127, the response information creating process performed by the response information creating unit 131.

In contrast, if the number of code block notified from the control information analyzing unit 114 is less than a predetermined threshold, the error counting unit 127 and the transmission stop control unit 128 do not operate. In such a case, if the TB error detecting unit 126 detects an error in a transport block, the response information creating unit 131 always creates a NACK, whereas, if the TB error detecting unit 126 does not detect an error in a transport block, the response information creating unit 131 always creates an ACK.

### Program

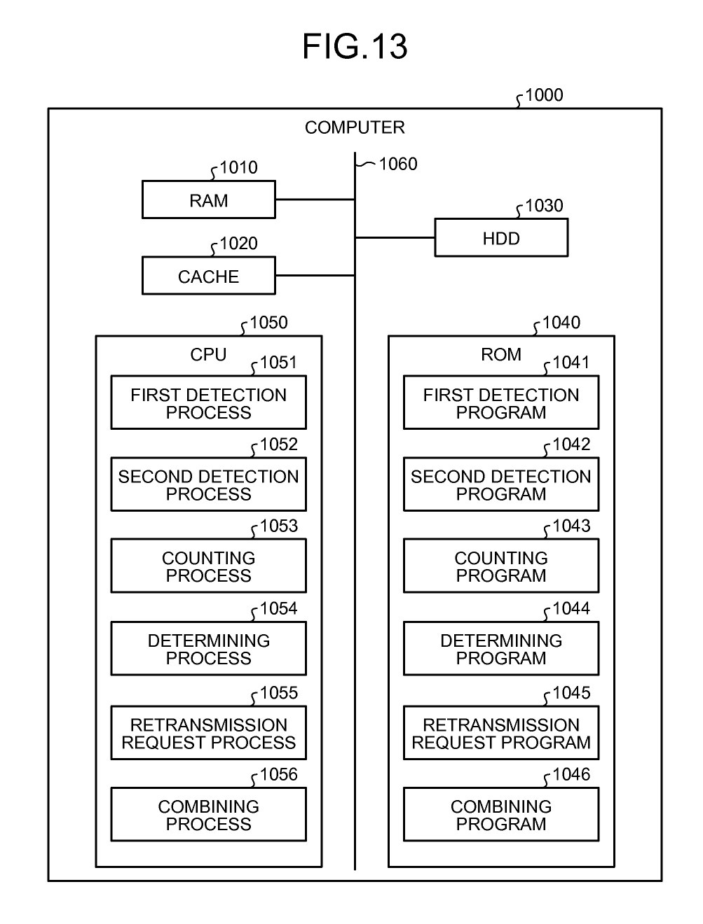

The various processes performed in the embodiments described above can be implemented by programs prepared in advance and executed by a computer system such as a personal computer or a workstation. Accordingly, in the following, a computer that executes a reception control program having the same function performed by the receiving apparatus 1 illustrated in FIG. 1 will be described as an example with reference to FIG. 13.

FIG. 13 is a block diagram illustrating a computer that executes a reception control program. As illustrated in FIG. 13, a computer 1000 includes a random access memory (RAM) 1010, a cache 1020, an HDD 1030, a read only memory (ROM) 1040, a central processing unit (CPU) 1050, and a bus 1060. The RAM 1010, the cache 1020, the HDD 1030, the ROM 1040, and the CPU 1050 are connected by the bus 1060.

The ROM 1040 stores therein, in advance, a reception control program having the same function as that performed by the receiving apparatus 1 illustrated in FIG. 1. Specifically, the ROM 1040 stores therein a first detection program 1041, a second detection program 1042, a counting program 1043, a determining program 1044, a retransmission request program 1045, and a combining program 1046.

Then, the CPU 1050 reads, from the ROM 1040, the first detection program 1041, the second detection program 1042, the counting program 1043, the determining program 1044, the retransmission request program 1045, and the combining program 1046 and executes them.

By doing so, as illustrated in FIG. 13, the first detection program 1041 functions as a first detection process 1051. The second detection program 1042 functions as a second detection process 1052. The counting program 1043 functions as a counting process 1053. The determining program 1044 functions as a determining process 1054. The retransmission request program 1045 functions as a retransmission request process 1055. The combining program 1046 functions as a combining process 1056.

The first detection process 1051 corresponds to the first detecting unit 2 illustrated in FIG. 1. The second detection process 1052 corresponds to the second detecting unit 3 illustrated in FIG. 1. The counting process 1053 corresponds to the counting unit 4 illustrated in FIG. 1. The determining process 1054 corresponds to the determining unit 5 illustrated in FIG. 1. The retransmission request process 1055 corresponds to the retransmission requesting unit 6 illustrated in FIG. 1. The combining process 1056 corresponds to the combining unit 8 illustrated in FIG. 1.

The above-described programs 1041 to 1046 are not always stored in the ROM 1040. For example, the programs 1041 to 1046 may also be stored in a “portable physical medium”, such as a flexible disk (FD), a CD-ROM, a DVD disk, a magneto-optic disk, an IC CARD, or the like that can be inserted into the computer 1000. Alternatively, the programs 1041 to 1046 may also be stored in a “fixed physical medium”, such as a hard disk drive (HDD), that can be arranged inside/outside the computer 1000. Alternatively, the programs 1041 to 1046 may also be stored in “another computer (or a server)” connected to the computer 1000 via a public circuit, the Internet, a LAN, a WAN, or the like. Then, the computer 1000 may also read and execute each program from the flexible disk or the like described above.

### System Configuration, Etc.

The components of each unit illustrated in the drawings are only for conceptually illustrating the functions thereof and are not always physically configured as illustrated in the drawings. In other words, the specific shape of a separate or integrated device is not limited to the drawings. Specifically, all or part of the device can be configured by functionally or physically separating or integrating any of the units depending on various loads or use conditions. For example, the demodulating unit 111 and the demodulating unit 121 illustrated in FIG. 5 may also be integrated. Furthermore, the demodulating unit 211, the demodulating unit 221, and the demodulating unit 241 illustrated in FIG. 11 may also be integrated.

According to an aspect of the receiving apparatus disclosed in the present application, an advantage is provided in that the receiving apparatus can prevent the situation in which a normal data packet is not received.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A receiving apparatus comprising:
a first detecting unit that performs error detection on a packet received from a transmitter;
a second detecting unit that performs error detection on each block, of a predetermined size, into which the packet is divided; and
a retransmission requesting unit that controls a retransmission request for the packet with respect to the transmitter on the basis of a detection result from the first detecting unit and a detection result from the second detecting unit.

2. The receiving apparatus according to claim 1, further comprising:
a counting unit that counts the number of blocks in which an error is detected by the second detecting unit, wherein
the retransmission requesting unit controls the retransmission request for the packet with respect to the transmitter on the basis of the number of blocks counted by the counting unit.

3. The receiving apparatus according to claim 2, further comprising:
a determining unit that determines, when an error is detected by the first detecting unit, whether the number of blocks counted by the counting unit is equal to or greater than a predetermined threshold, wherein
the retransmission requesting unit does not request the transmitter to retransmit the packet when the determining unit determines that the number of blocks is equal to or greater than the threshold, and
the retransmission requesting unit requests the transmitter to retransmit the packet when the determining unit determines that the number of blocks is less than the threshold.

4. The receiving apparatus according to claim 3, further comprising:
an acquiring unit that acquires the number of blocks contained in the packet, wherein
the determining unit determines whether the number of blocks counted by the counting unit is equal to or greater than the predetermined threshold when an error is detected by the first detecting unit and when the number of blocks acquired by the acquiring unit is equal to or greater than a predetermined threshold, and
the retransmission requesting unit stores the packet in a storing unit and requests the transmitter to retransmit the packet when an error is detected in the packet by the first detecting unit and when the number of blocks acquired by the acquiring unit is less than the predetermined threshold.

5. The receiving apparatus according to claim 1, further comprising:
a combining unit that combines, when the packet retransmitted from the transmitter is received in response to the retransmission request from the retransmission requesting unit, the received retransmitted packet with the packet stored in a storing unit, wherein
the retransmission requesting unit does not store the packet in the storing unit when the retransmission requesting unit does not request the transmitter to retransmit the packet, and
the retransmission requesting unit stores the packet in the storing unit when the retransmission requesting unit requests the transmitter to retransmit the packet.

6. A receiving method performed by a receiving apparatus that performs wireless communication with a transmitter, the receiving method comprising:
performing a first error detection on a packet received from the transmitter;
performing a second error detection on each block, of a predetermined size, into which the packet is divided; and
controlling, on the basis of a detection result at the first detection and a detection result at the second detection, a retransmission request from the receiving apparatus to the transmitter for the packet.

7. The receiving method according to claim 6, further comprising:
counting the number of blocks in which an error is detected at the second detection, wherein
the controlling includes controlling of the retransmission request for the packet with respect to the transmitter on the basis of the number of blocks counted at the counting.

8. The receiving method according to claim 7, further comprising:
determining, when an error is detected at the first detection, whether the number of blocks counted at the counting is equal to or greater than a predetermined threshold, wherein
requesting the transmitter to retransmit the packet is not performed at the controlling when it is determined, at the determining, that the number of blocks counted at the counting is equal to or greater than the threshold, and
the requesting the transmitter to retransmit the packet is performed at the controlling when it is determined, at the determining, that the number of blocks counted at the counting is less than the threshold.

9. The receiving method according to claim 8, further comprising:
acquiring the number of blocks contained in the packet, wherein
the determining includes determining whether the number of blocks counted at the counting is equal to or greater than the predetermined threshold when an error is detected at the first detection and when the number of blocks contained in the packet acquired at the acquiring is equal to or greater than a predetermined threshold, and
the controlling includes storing the packet in a storing unit and requesting the transmitter to retransmit the packet when an error is detected in the packet at the first detection and when the number of blocks acquired at the acquiring is less than the predetermined threshold.

10. The receiving method according to claim 6, further comprising:
combining the received retransmission packet with the packet stored in a storing unit when the packet that is retransmitted from the transmitter is received in response to the retransmission request at the controlling, and
storing the packet in the storing unit is not performed at the controlling when requesting the transmitter to retransmit the packet is not performed at the controlling, and
the storing the packet in the storing unit is performed at the controlling when the requesting the transmitter to retransmit the packet is performed at the controlling.

11. A wireless communication system comprising:
a transmitter and
a receiving apparatus, the receiving apparatus including
a first detecting unit that performs error detection on a packet received from the transmitter,
a second detecting unit that performs error detection on each block, of a predetermined size, into which the packet is divided, and
a retransmission requesting unit that controls a retransmission request for the packet with respect to the transmitter on the basis of a detection result from the first detecting unit and a detection result from the second detecting unit.
